(19) United States
(12) Patent Application Publication
(10) Pub. No.: US 2024/0336800 A1
(43) Pub. Date: Oct. 10, 2024

(54) STAIN RESISTANT ARCHITECTURAL COMPOSITIONS

(71) Applicant: Columbia Insurance Company, Omaha, NE (US)

(72) Inventors: Samantha Marie Mascetti, Hackensack, NJ (US); Xinyu Wang, Hillsborough, NJ (US); Clarena Shavel, East Stroudsburg, PA (US); Paulina Ogorzalek, Bloomsbury, NJ (US); Yong Yang, Hillsborough, NJ (US); Gary Dandreaux, River Edge, NJ (US)

(21) Appl. No.: 18/131,137

(22) Filed: Apr. 5, 2023

(51) Int. Cl. C09D 119/02; C09D 4/00; C09D 5/14; C09D 7/41; C09D 7/65; C09D 185/02

(52) U.S. Cl. CPC C09D 119/02; C09D 4/00; C09D 5/14; C09D 7/41; C09D 7/65; C09D 185/02

(57) ABSTRACT

Disclosed herein is an aqueous architectural composition forming a paint film on a substrate capable of resisting hydrophobic and hydrophilic stains. The architectural composition includes a film forming latex resin, a high molecular weight silicone resin, and a wax microsphere. The stain resistant architectural composition may also include at least one organic extender pigment, a fluorosurfactant and a phosphate monomer.

### FIELD OF THE INVENTION

The present invention is directed paint films formed by aqueous architectural compositions, including paints and deck stains, that are stain resistant, i.e., resistance to discoloration by hydrophobic and hydrophilic stains, as well as being cleansable.

### BACKGROUND OF THE INVENTION

Commercial waterborne or aqueous latex paints and deck stains are not resistant to all common stains. When stains are in contact with a paint film, visible marks remain on the paint film which need to be cleaned to restore the paint film's visual appearance by various cleaning methods. Such commercial paints are deemed to be cleansable but are not necessarily stain resistant. Some commercial paints lack durability and degrade when cleaned with chemical cleaners, and some have low resistance to scrubbing and poor gloss/sheen retention.

Generally, paint films formed from architectural compositions can resist either hydrophilic stains or hydrophobic stains depending on the hydrophobicity/hydrophilicity of the polymer latex resins in the architectural compositions, but typically do not resist both types of stains. As used herein, architectural compositions include at least paints and deck stains.

Utilizing latex resin particles having small particle size, e.g., less than 130 nm, would create a tighter film, e.g., smaller interstitial spacing among the latex particles, which may minimize the penetration of stains into the paint film.

Multiple approaches to stain resistant architectural compositions have been suggested in the patent literature. U.S. Pat. No. 8,158,713 discloses a stain resistant coating composition having thermoplastic latex particles copolymerized from primarily mono-ethylenically unsaturated monomers, and a phosphorus containing monomers, an ethyl acrylate or methyl acrylate monomer, and a beta-dicarbonyl or cyanocarbonyl monomer. U.S. Pat. No. 8,318,848 discloses a coating composition with a copolymer made from mostly mono-ethylenically unsaturated monomer monomers, small amount of carboxylic acid and small amount of phosphorus-containing monomer, and a non-ionic surfactant. U.S. Pat. No. 8,158,714 discloses a method of mixing the opacifying pigment with a thickening agent at a certain shear rate and mix it with a latex binder copolymer of acrylic and phosphorus-containing monomer.

U.S. Pat. No. 10,005,921 discloses a stain resistant paint composition wherein the polymer comprising 3%-70% of vinyl acetate, 2%-65% of styrene, 20%-55% of (meth)acrylate, 0.1%-6% of wax, and a 14%-55% pigment. U.S. Pat. No. 10,005,921 discloses a stain resistant paint composition wherein the polymer comprising 25%-90% of vinyl acetate, 5-75% of vinyl ester of versatic acid and/or vinyl ester of 2-ethyl hexanoic acid, 0.1%-6% of wax, and a 14%-55% pigment.

U.S. Pat. No. 10,800,927 teaches a composition for improved stain removal and not necessarily stain resistance, comprising an emulsion copolymer of a monomer mixture comprising a monomer having a formula:

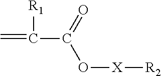

wherein R1 is H or methyl, X is a divalent organic alkylene oxide group and R2 is H or an aliphatic or aromatic hydrocarbon group, and a phosphate surfactant.

CN 103849267 discloses a stain resistant composition with acrylic resin film former, PE wax and fluoro-surfactant, which is known to provide some stain resistance.

U.S. Pat. No. 11,059,980 discloses a stain resistant composition comprising (i) an ethylenically unsaturated nonionic monomer, (ii) a first acid monomer and (iii) a second acid monomer. The ratio of the first acid monomer to second is greater than 0.7. Examples of the first acid monomer is a phosphate-based monomer and of the second aid monomer is methacrylic acid (MAA). This patent requires three different film forming monomers and MAA as the second acid. Stain resistance as disclosed in U.S. Pat. No. 11,059,980 means stains with a combination of hydrophobic and hydrophilic stains to high residual visible stain, i.e., ΔE of less than 80.

U.S. published patent application No. 2020/0354603 discloses a composition with some stain resistance. The composition comprises (i) a polymer system, a coalescent aid and a pigment. The polymer system comprises a latex polymer and an alkali soluble resin (ASR) “blended” together. The ASR has a Mw from 1,500 to 20,000; and an acid number from 100 to 250 and makes up 2.5%-15 wt. % to all the polymers.

The above patents and patent applications represent disparate approaches to stain resistant paint formulations, but do not address the issue of resisting both hydrophilic and hydrophobic stains.

Hence, there remains a need for stain resistant architectural compositions that are capable of resisting both hydrophobic and hydrophilic stains.

### SUMMARY OF THE INVENTION

Hence, an embodiment of the present invention is directed to an aqueous architectural composition forming a paint film on a substrate capable of resisting hydrophobic and hydrophilic stain comprising a film forming latex resin for forming the paint film, an optional opacifying pigment, a silicone resin, a wax microsphere, and at least one organic extender pigment. The silicone resin has a weigh molecular weight of greater than about 10,000, preferably greater than about 15,000, preferably greater than about 20,000 Daltons, preferably greater than about 25,000 Daltons, preferably greater than about 30,000 Daltons, and less than about 100,000 Daltons. The PE wax microsphere has a mean diameter (D50) ranging from about 6 microns to 18 microns, and ranges from about 3 wt. % to about 9 wt. %, preferably from about 3.5 wt. % to about 8.5 wt. %, preferably from about 4.wt. % to about 7.5 wt. % of the aqueous architectural composition. The silicone resin ranges from about 1 wt. % to about 4 wt. %, preferably from about 1.25 wt. % to about 3.5 wt. %, preferably from about 1.5 wt. % to about 3 wt. % of the aqueous architectural composition. Preferably all the extender pigments are organic.

Preferably, the film forming latex resin comprises a phosphate monomer, and the phosphate monomer ranges from 0.1 wt. % to 1 wt. %, preferably 0.5-0.9 wt. %, more preferably 0.6-0.8 wt. % of all the monomers in the latex resin.

Preferably, the film forming latex resin is substantially free of wax seeded latex, preferably free of wax seeded latex.

Preferably, the film forming latex resin comprises principally (meth)acrylate monomers or vinyl and (meth)acrylate monomers.

Preferably, the aggregate Tg for the film forming copolymers ranges from 0° C. to 50° C. as calculated by the Flory Fox equation and preferably from 0° C. to 30° C. or from 2.5° C. to 27.5° C. or from 5° C. to 25° C.

Preferably, the aqueous architectural composition 1 further comprises a fluorosurfactant, and the fluorosurfactant comprises less than 1 wt. %, preferably from 0.1 wt. % to 0.3 wt. %, preferably from 0.15 wt. % to about 0.25 wt. % of the aqueous architectural composition.

Preferably, the aqueous architectural composition may comprise a Gemini surfactant, a polyether-siloxane surfactant, or a neutralized alcohol phosphate-type surfactant, from 0.25 wt. % to 0.75 wt. %, preferably from 0.35 wt. % to 0.65 wt. % of the paint composition.

### DETAILED DESCRIPTION OF THE PREFERRED EMBODIMENTS

The present invention is directed to architectural compositions that comprise components selected to resist both hydrophobic and hydrophilic stains. The inventive architectural compositions form paint films that resist both types of stains, as well as scuff marks. Preferably, these paint films are also cleansable using common household mild cleaning products. Stain resistance differs from cleansability in that it resists stain from remaining on the paint films after the stains run off or are wiped off the paint films without cleaning. Separate stain resistant test and cleansability test are described below.

The inventive architectural compositions, similar to conventional architectural compositions, which include various commercial lines, finishes and tintable paint bases, comprise one or more waterborne or aqueous base latex resins admixed with an opacifying pigment for certain tintable bases, such as titanium dioxide, and common additives, including but not limited to dispersants/rheological modifiers, surfactants, defoamers, inorganic extender pigments, coalescent aids, biocides, etc. The inventive architectural compositions comprise selected components that either replace one or more of the additives, or are in addition to the common additives.

One selected component of the inventive architectural compositions is a silicone resin having weight average molecular weight (MWw) greater than about 10,000 Daltons or greater than about 15,000 Daltons, preferably more than about 20,000 Daltons or greater than about 25,000 Daltons, and more preferably greater than about 30,000 Daltons, and less than about 100,000 Daltons. The silicone resin is added in a range from about 1 wt. % to about 4 wt. %, preferably from about 1.25 wt. % to about 3.5 wt. % and more preferably from about 1.5 wt. % to about 3 wt. %. While the silicone resin is generally film forming, at the preferred percentage range the silicone would not independently form a film and is used in addition to the primary film forming resin. Silicone resin provides hydrophobicity, slip and mar resistance to the paint film.

As used herein, weight percentages when used in the polymerization of a copolymer refer the weight percentages of solid monomer weight, i.e., without taking into account water or other liquid(s). Weight percentages when used in the letdown stage or admixture of the copolymer(s), opacifying pigment, extender pigment, and additives to produce architectural compositions refer to the weight percentages of the total paint composition including water and other liquids. The weight of the resin listed in paint/stain formulations includes water and/or solvent that suspends the copolymer(s).

Suitable silicone resins are available from WorleeSol SE 420W from Worlee-Chemie, Dow Corning DOWSIL™ 210S, CoatOSil® DRI waterborne silicone from Momentive Performance Materials, Inc., the SilRes® BS family of water-dilutable silicone resin emulsions from Wacker Chemie AG, Hydropalat SL 3682 from BASF, and Siltech C-4405 from Siltech Corporation.

Another selected component is wax microspheres or wax particles with a mean diameter, D₅₀, from about 6 microns to about 18 microns. Wax particles with different mean diameters can be used together. A preferred wax particle is a polyethylene (PE) wax particle and is added to the architectural compositions from about 3.0 wt. % to about 9 wt. %, preferably from about 3.5 wt. % to about 8.5 wt. % and more preferably from about 4 wt. % to about 7.5 wt. %.

Micronized wax microspheres or powders are available commercially from Honeywell as ACumist micronized, oxidized polyethylene powders having volume average particle sizes (mV) from about 6 to about 7.5 μm (D₅₀ of 6 microns), from about 10 to about 13 μm (D₅₀ of 12 microns), from about 16 to about 19 μm (D₅₀ of 18 microns) and designated as the ACumist A-6, A-12 and A-18, respectively. Combinations of these particle sizes can be used in the same paint or stain composition. Other suitable, commercially available oxidized HDPE wax powders include but are not limited to Petrolite C and Petrolite E classes from Baker-Petrolite Corporation, and Deurex EO from Deurex AG.

An optional fluorosurfactant in an amount sufficient to minimize or prevent the creation of dimples or small craters on the surface of the paint film is utilized. Fluorosurfactant is added from about 0.1 wt. % to about 0.3 wt. %, preferably from about 0.15 wt. % to about 0.25 wt. %. A small amount of surfactant other than fluorosurfactant of less than about 1 wt. % can be added.

Fluorosurfactants generally comprise a polar hydrophilic head and a highly hydrophobic fluorocarbon tail. Fluorosurfactants are described in N. M. Kovalchuk et al., “Fluoro-vs Hydrocarbon Surfactants: Why Do They Differ in Wetting Performances?” in Advances in Colloid and Interface Science, 210 (2014) 65-71, which is incorporated herein by reference in its entirety. Fluorosurfactants significantly reduce the surface tension and the surface energy of the paint compositions, as well as the surface energy of the paint films formed by these paint compositions. Fluorosurfactants can reduce the surface tension and surface energy significantly more than conventional hydrocarbon surfactants. Suitable fluorosurfactants include the Capstone® FS- ##family of fluorosurfactants commercially available from Chemours, SURFLON® fluorosurfactants commercially available from AGC Seimi Chemical Co., Ltd., and the FC- ##fluorosurfactants from 3M.

Other surfactants can be used instead of fluorosurfactants or in addition to fluorosurfactants. These other surfactants include, but are not limited to, Gemini surfactants, polyether-siloxane surfactants, neutralized alcohol phosphate-type surfactants, and can be added preferably from 0.25 wt. % to 0.75 wt. %, preferably from 0.35 wt. % to 0.65 wt. % of the paint compositions when used without fluorosurfactants. Suitable other surfactants are commercially available as Stepcote W-877, Tego Twin 4100, Additol XW 6580 and the Dynol series. For architectural compositions to wet the substrate to be covered without defects on paint films, such as cratering or pitted paint films, the surface tension of the paint should be lower than the that of the architectural compositions, fluorosurfactants are effective in reducing the surface tension of the architectural compositions. Gemini surfactants, polyether-siloxane surfactants, and neutralized alcohol phosphate-type surfactants may be used as alternatives to fluorosurfactants at a higher amounts to reduce the surface tension of architectural compositions.

Another selected component is organic extender pigment instead of inorganic extender pigments. Extender pigments are used to alter the pigment to resin ratio (PVC) or to adjust the finishes or glosses of the paint composition. Extender pigments are discussed in commonly owned US patent publication number 11,518,893, which is incorporated herein by reference in its entirety. Generally, inorganic extender pigments, such as diatomaceous earth (amorphous silica), silica, ground and precipitated calcium carbonate, ground and calcined aluminum silicate, magnesium silicate (talc), aluminum potassium silicate (mica), nepheline syenite, etc., are added to paints. The present co-inventors have discovered that inorganic pigments are generally more hydrophilic and contribute to more staining. Moreover, inorganic extender pigments contribute to higher porosity on the film surface that can attract and retain more stains. In one preferred embodiment, no inorganic extender pigment is used. In an alternative embodiment, certain inorganic pigment, e.g., harder pigments or pigments with rounder shapes that can be encapsulated substantially within or by the paint film, can be included.

Suitable organic extender pigments, which are not film forming, include but not limited to opaque acrylic copolymer (Ropaque™ Ultra or Ultra EF), styrene acrylic resin (Joncryl™), polyurethane (PU) microsphere. Suitable organic extender pigments may also include poly-butylacrylate microspheres and silicone microspheres.

The styrene acrylic resin pigments (Joncryl™) are low molecular weight, high acid number, polymeric particles with a molecular weight of about 1000 to about 20,000, preferably from about 5,000 to about 17,000, and more preferably from about 8,000 to about 17,000, and an acid number from about 150 to about 250, preferably from about 200 to about 250 and are soluble in alkali solutions.

The PU microspheres, which can be used as extender pigments, are solid particles and are elastic. Such solid particles can resist breakage due to their elasticity. PU microspheres or particles are commercially available as Decosphaera®, Adimatt®, and Sphaerawet® from SuperColori in Italy (www.supercolori.com) and are available dispersed in water or as dry beads. PU microspheres are also available from KOBO located in New Jersey and as Art Pearl™ “C” series from Negami Chemical Industrial Co., Ltd. in Japan.

The selected components described above are admixed in combinations and sub-combinations thereof with film-forming resin(s) and opacifying pigments to form the inventive architectural composition, as shown in the examples below. One or more selected components may be omitted from the inventive architectural composition. As used herein, unless otherwise indicated, the selected components are non-film forming and are added directly to the architectural compositions, e.g., paints and deck stains.

Opacifying pigments preferably include titanium oxide, which are widely available, including Tronox TiONA® 826 or TIONA® 813 and Ti-Pure R-706, among others. Another opacifying pigment is zinc oxide. Certain 4-base tintable paints do not include opacifying pigment.

Film forming resins are homo-polymerized or co-polymerized, e.g., by emulsion polymerization, from all acrylic resin copolymers or vinyl-acrylic copolymers. Styrene and other unsaturated ethylenically monomers can be copolymerized.

Unless otherwise indicated below in the exemplary formulations, the film forming resins suitable for the present invention are copolymerized from the monomers discussed herein. The film forming resin in the present invention does not rely on wax seeded latex as disclosed in commonly owned U.S. Pat. Nos. 8,980,995 and 11,230,645 and U.S. patent application publication number US 2021/0230442. The present inventors sought to solve a different problem in the art, i.e., hydrophobic and hydrophilic stain resistance, than the earlier commonly owned patents and patent application. The film forming resin in the present invention also does not rely on a combination of three resins (wax seeded latex, hard latex with Tg>30° C., and elastomeric resins) to resist chipping of the dry paint films, as stated in the '442 patent publication. The present invention also does not rely on a combination of wax seeded latex resin, wax particles having a range of particle sizes and a coalescent aid in certain embodiments to resist scuffing of the dry paint films, as stated in the '645 patent.

The wax seeded latex is preferably omitted in the present invention. In other words, the film forming resins utilized in the present invention is preferably free or substantially free of wax seeded latex. As used herein, substantially free means less than about 5 wt. %, preferably less than about 2.5 wt. % and more preferably less than about 1.0 wt. % of the total monomer weight.

Suitable latex particles include but are not limited to acrylic, vinyl, vinyl-acrylic or styrene-acrylic polymers or copolymers. The latex particles coalesce and/or crosslink to form a paint film on a substrate. Latexes made substantially from acrylic monomers are preferred for the present invention, as illustrated in the Examples below. Exemplary, non-limiting monomers suitable to form the emulsion latex particles for the present invention are described below.

Any (meth)acrylic monomers can be used in the present invention. Suitable (meth)acrylic monomers include, but are not limited to methyl(meth)acrylate, ethyl (meth)acrylate, butyl(meth)acrylate, iso-octyl(meth)acrylate, lauryl(meth)acrylate, 2-ethylhexyl(meth)acrylate, stearyl(meth)acrylate, isobornyl(meth)acrylate, methoxyethyl (meth)acrylate, 2-ethyoxyethyl(meth)acrylate, 2-hydroxyethyl(meth)acrylate, 2-hydroxybutyl (meth)acrylate, dimethylamino ethyl(meth)acrylate, diethylaminoethyl(meth)acrylate, dimethylaminopropyl(meth)acrylamide, alkyl(meth)acrylic acids, such as methyl(meth)acrylate acids, (meth)acrylic acids, wet adhesion monomers, such as N-(2-methacryloyloxyethyl)ethylene urea, and multifunctional monomers such as divinyl benzene, diacrylates, for crosslinking functions etc., acrylic acids, ionic acrylate salts, alkacrylic acids, ionic alkacrylate salts, haloacrylic acids, ionic haloacrylate salts, acrylamides, alkacrylamides, monoalkyl acrylamides, monoalkyl alkacrylamides, alkyl acrylates, alkyl alkacrylates, acrylonitrile, alkacrylonitriles, dialkyl acrylamides, dialkyl alkacrylamides, hydroxyalkyl acrylates, hydroxyalkyl alkacrylates, only partially esterified acrylate esters of alkylene glycols, only partially esterified acrylate esters of non-polymeric polyhydroxy compounds like glycerol, only partially esterified acrylate esters of polymeric polyhydroxy compounds, itaconic acid, itaconic mono and di-esters, and combinations thereof. The preferred alkyl(meth)acrylate monomers are methyl methacrylate and butyl acrylate.

Preferred monomers containing aromatic groups are styrene and α-methylstyrene. Other suitable monomers containing aromatic groups include, but are not limited to, 2,4-diphenyl-4-methyl-1-pentene, 2,4-dimethylstyrene, 2,4,6-trimethylstyrene, 2,3,4,5,6-pentafluorostyrene, (vinylbenzyl)trimethylammonium chloride, 2,6-dichlorostyrene, 2-fluorostyrene, 2-isopropenylaniline, 3 (trifluoromethyl) styrene, 3-fluorostyrene, α-methylstyrene, 3-vinylbenzoic acid, 4-vinylbenzyl chloride, α-bromostyrene, 9-vinylanthracene, and combinations thereof.

Preferred monomers containing primary amide groups are (meth)acrylamides. Suitable monomers containing amide groups include, but are not limited to, N-vinylformamide, or any vinyl amide, N,N-dimethyl(meth)acrylamide, N-(1,1-dimethyl-3-oxobutyl)(meth)acrylamide, N-(hydroxymethyl)(meth)acrylamide, N-(3-methoxypropyl)(meth)acrylamide, N-(butoxymethyl)(meth)acrylamide, N-(isobutoxymethyl)acryl(meth)acrylamide, N-[tris(hydroxymethyl)methyl]acryl(meth)acrylamide, 7-[4-(trifluoromethyl) coumarin](meth)acrylamide, 3-(3-fluorophenyl)-2-propenamide, 3-(4-methylphenyl)(meth)acrylamide, N-(tert-butyl)(meth)acrylamide, and combinations thereof.

These monomers can be polymerized with acrylic monomers, listed above. General formula for vinyl (form)amides are:

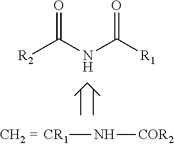

and (meth)acrylamides:

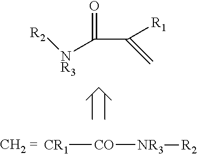

where R1 and R2 can be —H, —CH₃, —CH₂CH₃, and other substituted organic functional groups and R3 can by —H, an alkyl or an aryl.

In one embodiment, styrene monomers, such as styrene, methylstyrene, chlorostyrene, methoxystyrene and the like, are preferably co-polymerized with (meth)acrylamide monomers.

In one embodiment, the aqueous latex polymer may also comprise vinyl monomers. Monomers of this type suitable for use in accordance with the present invention include any compounds having vinyl functionality, i.e., —CH═CH₂ group. Preferably, the vinyl monomers are selected from the group consisting of vinyl esters, vinyl aromatic hydrocarbons, vinyl aliphatic hydrocarbons, vinyl alkyl ethers and mixtures thereof.

Suitable vinyl monomers include vinyl esters, such as, for example, vinyl acetate, vinyl propionate, vinyl laurate, vinyl pivalate, vinyl nonanoate, vinyl decanoate, vinyl neodecanoate, vinyl butyrates, vinyl caproate, vinyl benzoates, vinyl isopropyl acetates and similar vinyl esters; nitrile monomers, such (meth)acrylonitrile and the like; vinyl aromatic hydrocarbons, such as, for example, styrene, methyl styrene and similar lower alkyl styrene, chlorostyrene, vinyl toluene, vinyl naphthalene and divinyl benzene; vinyl aliphatic hydrocarbon monomers, such as, for example, vinyl chloride and vinylidene chloride as well as alpha olefins such as, for example, ethylene, propylene, isobutylene, as well as conjugated dienes such as 1,3-butadiene, methyl-2-butadiene, 1,3-piperylene, 2,3-dimethyl butadiene, isoprene, cyclohexene, cyclopentadiene, and dicyclopentadiene; and vinyl alkyl ethers, such as, for example, methyl vinyl ether, isopropyl vinyl ether, n-butyl vinyl ether, and isobutyl vinyl ether.

Commonly used monomers with their glass transition temperature (Tg) and solubility in water are shown below. Since it is uncommon in the scientific literature to discuss the hydrophobicity and hydrophilicity of monomers quantitatively, the present inventors are utilizing their solubility in water as a proxy variable.

| Monomer | Solubility in Water at T° | Tg (° C.) |
|---|---|---|
| BA | 2 g/l at 23° C. | −54 |
| 2-EHA | 0.0096 g/l at 25° C. | −50 |
| EA | 15-20 g/l at 25° C. | −24 |
| MMA | 15 g/l at 30° C. | 105 |
| MA | 10-50 g/l at 22° C. | 10 |
| MAA | 89 g/l at 20° C. | 228 |
| Styrene | 0.3 g/l at 25° C. | 100 |
| VA | 20 g/l at 25° C. | 30 |
| iOMP | <0.00767 g/l at 20° C. | n/a |
| DMA | 1 μg/l at 25° C. | −65 |

2-EHA is known to be hydrophobic and has a very low solubility; MMA has a relatively high solubility and BA has a solubility between 2-EHA and MMA.

The aggregate Tg for the film forming copolymers ranges from 0° C. to 50° C. as calculated by the Flory Fox equation and preferably from 0° C. to 30° C. or from 2.5° C. to 27.5° C. or from 5° C. to 25° C.

Other exemplary suitable polymer resin copolymers include those that are polymerized with small amount of phosphate monomers, such as Resin 1 and 2 as shown in Table 1 below.

TABLE 1

| | |
|---|---|
| Resin 1 | Resin 2 |

| Material | Weight % | |
|---|---|---|
| Sodium bicarbonate (Buffer) | 0.07 | 0.19 |

| | |
|---|---|
| Rheological modifier/thickener | 0.56 |

| | |
|---|---|
| Sodium C₁₄-C₁₆ Sulfonate | 0.47 |

| (Surfactant) | |
|---|---|
| Tridecyl alcohol ethoxylate (non-ionic | 0.39 |
| surfactant) | |
| Sodium C12-C14 linear alcohol ether | 0.32 |
| sulfate (surfactant) | |
| C12-C14 linear alcohol ethoxylate | 0.60 |
| (surfactant) | |

| | | |
|---|---|---|
| Ammonium phosphate, | 0.26 | 0.24 |

polyoxyethylene tridecyl ether
(Surfactant)

| | | |
|---|---|---|
| mono-and di-phosphate esters of 2- | 0.94 | 0 |

hydroxethylmethacrylate

| | | |
|---|---|---|
| N-(2-Methacryloyloxyethyl)-ethylene | 0.51 | 0.75 |

urea (wet adhesion monomer)

| Butyl acrylate (BA) | 25.00 | 11.13 |
|---|---|---|
| Methyl methacrylate (MMA) | 46.18 | |
| Methyl acrylate (MA) | 20.96 | 0 |
| Methyl acrylic acid (MAA) | 0.58 | |
| Vinyl acetate (VA) | 0 | 85.36 |
| Acetoacetoxyethyl methacrylate | 3.56 | 0 |

(AAEM) (cross-linking monomer)

| | |
|---|---|
| Ethylenediaminetetraacetic acid | 0.06 |

(EDTA) (chelator)

| | | |
|---|---|---|
| Sodium Persulfate (Na₂S₂O₈) | 0.21 | 0.34 |

(Initiator)

| | | |
|---|---|---|
| t-butyl hydroperoxide (tBHp) (redox | 0.12 | 0.02 |

chaser)

| Bruggolite FF6M (redox chaser) | 0.17 | | 0.02 | |
|---|---|---|---|---|
| Ammonium hydroxide (pH modifier) | 0.12 | | | |
| Biocide blend § | 0.04 | | 0.07 | |
| TOTAL | 99.25% | | 99.99% | |
| Particle size (volume average) | 119 | nm | 360 | nm |
| MFFT (ISO 2115) | 21.8° | C. | ~15° | C. |

| | | |
|---|---|---|
| Resin solids % | 49.65% | 51.7% |

§ 1,2-benzisothiazolin-3-one (BIT), N-(butyl)-1,2-benzisothiazolin-3-one (BBIT), 5-chloro-2-methyl-4-isothiazolin-3-one (CIT or CIMIT), and/or 2-methyl-4-isothiazolin-3-one (MIT).

The latex particles may have a crosslinking monomer added to the monomer mixtures for an inner stage, such as the core or the two inner cores/stages or in the first portion of the monomer mixture. Cross-linking can improve the toughness of the dried paint film, e.g., to improve its resistance to scrubbing or to have improved scrubbability. Preferred crosslinking monomers include, but are not limited to acetoacetoxyethyl methacrylate (AAEM) and diacetone acrylamide (“DAAM”). The AAEM and/or DAAM crosslinking monomer can be copolymerized up to 10 wt. % of total monomers, preferably from 1 wt. % to 8 wt. %, more preferably from 2 wt. % to 6 wt. % and more preferably from 3.5 wt. % to 4.5 wt. %.

Other suitable crosslinking monomers include but are not limited to diacetone methacrylamide (DAMAM), allyl methyl acrylate (AMA) and/or 1,4-butanediol diacrylate, which is/are added to the pre-emulsion composition and can be co-polymerized with film forming monomers to form latex particles.

It has been reported that the cross-linking of polymers is provided by reacting the AAEM or DAAM moiety with a suitable cross-linking agents in the aqueous phase including adipic acid dihydrazide (“ADH”). ADH cross-linking agent through a keto-hydrazide reaction has a substantial reaction rate in an aqueous solution. (“The Diacetone Acrylamide Cross-linking Reaction and its Influence on the Film Formation of an Acrylic Latex,” Journal of Coatings Technology and Research, 5 (3), 285-297, 2008.) To minimize this premature cross-linking, the ADH hydrazine is substantially substituted with hydrazone(s) or blocked hydrazine particles discussed in commonly owned United States published patent application No. 2012/0142847 and in commonly owned U.S. Pat. No. 9,040,617, which are incorporated herein by reference in their entireties. The hydrazone crosslinking particles do not react with the AAEM or DAAM moiety during storage, and are converted to hydrazine crosslinking particles when the aqueous component evaporates after application to a substrate.

Exemplary suitable polymer resin compositions also include vinyl acrylic copolymers included in Resin 2 shown in Table 1.

Paint compositions are made in the letdown phase, i.e., after the latex resins are polymerized or otherwise made available, when the latex resin(s), opacifying pigments and additives are admixed to make the pains. An exemplary paint composition (Paint 1) is shown below utilizing Resin 1 in Table 2A.

TABLE 2A

| Letdown phase: Paint 1 | Weight % |
|---|---|
| Water | 8.657 |

Biocide

| | |
|---|---|
| BIT | 0.099 |
| Zinc pyrithione (including zinc oxide) | 0.099 |

Dispersant

| | |
|---|---|
| Ammonium salt of hydrophobic polymer | 0.718 |

Opacifying pigment

| | |
|---|---|
| Titanium dioxide | 19.741 |

Organic Extender Pigments

| | |
|---|---|
| Polyethylene wax microspheres/particles (D₅₀ = | 3.455 |
| 6 nm) | |
| non-film-forming acrylic polymer hollow | 2.665 |
| sphere opaque pigment | |
| Styrene acrylic resin in solution | 1.974 |
| high molecular weight silicone | 2.961 |

Defoamers

| | |
|---|---|
| Polysiloxane (hyperbranched polymer with | 0.099 |
| organo-modified silicones) | |
| Paraffinic (blend of hydrophobic silica in | 0.049 |
| mineral oil) | |

pH modifier

| | |
|---|---|
| Ammonium Hydroxide | 0.148 |

Film-forming Resin

| | |
|---|---|
| Latex Resin 1 (including water) | 53.956 |

Coalescent Aid

| | |
|---|---|
| Benzoate esters | 3.257 |

Rheology modifiers/Thickeners

| | |
|---|---|
| Hydrophobically modified polyether | 1.382 |
| Polyurethane resin | 0.740 |
| TOTAL | 100% |

Additional finishes of Paint 1 made with Resin 1 were also prepared, as shown in Table 2B.

TABLE 2B

| | Weight % | | |
|---|---|---|---|
| Letdown phase: Paint 1 | Satin | Eggshell | Matte |
| Water | 8.657 | 11.647 | 16.198 |

Biocide

| | | | |
|---|---|---|---|
| BIT | 0.099 | 0.099 | 0.099 |
| Zinc pyrithione (including zinc | 0.099 | 0.099 | 0.099 |
| oxide) | | | |

Dispersant/Surfactant

| | | | |
|---|---|---|---|
| Ammonium salt of | 0.718 | 0.862 | 0.825 |
| hydrophobic polymer | | | |
| Fluorosurfactant | 0 | 0.198 | 0.199 |

Opacifying pigment

| | | | |
|---|---|---|---|
| Titanium dioxide | 19.741 | 19.761 | 19.851 |

Organic Extender Pigments

| | | | |
|---|---|---|---|
| Polyethylene wax | 3.455 | 0.494 | 0 |
| microspheres/particles (D₅₀ = | | | |
| 6 μm) | | | |
| Polyethylene wax | | 3.755 | 4.963 |
| microspheres/particles (D₅₀ = | | | |
| 12 μm) | | | |
| Polyethylene wax | | | 3.97 |
| microspheres/particles (d₅₀ = | | | |
| 18 μm) | | | |
| non-film-forming styrene | 2.665 | 2.668 | 2.68 |
| acrylic copolymer | | | |
| Styrene acrylic resin in | 1.974 | 3.458 | 3.97 |
| solution | | | |
| high molecular weight silicone | 2.961 | 2.964 | 2.978 |

Defoamers

| | | | |
|---|---|---|---|
| Polysiloxane (hyperbranched | 0.099 | 0.049 | 0.099 |
| polymer with organo-modified | | | |
| silicones) | | | |
| Paraffinic (blend of | 0.049 | 0.049 | 0.05 |
| hydrophobic silica in mineral | | | |
| oil) | | | |

pH modifier

| | | | |
|---|---|---|---|
| Ammonium Hydroxide | 0.148 | 0.148 | 0.149 |

Film-forming Resin

| | | | |
|---|---|---|---|
| Latex Resin 1 (including | 53.956 | 47.426 | 37.221 |
| water/liquids) | | | |

Coalescent Aid

| | | | |
|---|---|---|---|
| Benzoate esters | 3.257 | 3.656 | 3.474 |

Rheology modifiers/Thickeners

| | | | |
|---|---|---|---|
| Hydrophobically modified | 1.382 | 1.482 | 1.191 |
| polyether | | | |
| Polyurethane resin | 0.740 | 1.186 | 1.98 |
| TOTAL | 100% | 100% | 100% |

The inventive architectural compositions are compared to commercial paints to determine their relative cleansability under the COR-MTD-119 standard, and their stain resistant properties under a newly developed test.

The stain removal test conducted in these experiments corresponds to the Master Paint Institute (MPI) COR-MTD-119 standard. Higher values indicate that the stains were more difficult to remove from the paint film. Lower values are more preferred. The numbers reported are the sum of the changes in color readings (Delta E values in CIE2000 units) measured with a spectrophotometer of a pre-stained paint film and post-stained-and-washed paint film after a number of different stains are applied to the paint film. The stains include hot regular coffee, red cooking wine, tomato ketchup, yellow mustard and graphite. The cleaning solution comprises 0.5% nonyl phenoxy ethanol, 0.25% trisodium phosphate (TSP) and 99.25% deionized water. The cleaning solution is applied by a 430 g sponge/holder for 500 cycles. The changes of color caused by each stain are added and reported for each Example.

In the COR-MTD-119 standard, except for graphite, which is hydrophobic, the other stains are hydrophilic. TTP (raw umber pigment containing iron oxide and manganese oxide, white petroleum jelly and Isopar™ L synthetic isoparaffinic hydrocarbon solvent from ExxonMobil) and Litter (lanolin, petroleum jelly, lamp black pigment, margarine, and mineral oil) are hydrophobic stains.

A stain resistance test was developed by the co-inventors and was utilized to show the stain resistance capability of the inventive architectural compositions. For this test, two coats of paint are applied over one coat of primer on sheetrock. Then the painted sheetrock is cured in the lab for two days before the stains are applied. Nine milliliters of liquid stains are applied with an 8-mil gap cube applicator, and solid stains are drawn on sheetrock lying flat on table. After the stains are applied, the board is immediately lifted vertically for one minute. After one minute, a gentle cleaning method that use five wipes of cleaning solution (Lysol for difficult stains and a mild detergent for easier stains) followed by three wipes with water using a sponge. No or minimal pressure is applied with the sponge.

The stain resistance of paint films can be judged visually by human testers or viewers assigning a score of 1 (low stain resistance, high stain observed) to 5 (no stain observed). Black and blue marker, crayon, pencil, ball point pen, lipstick, wine/juice are the selected stains. Alternatively, the stain resistance can also be obtained using a spectrophotometer to measure the stain resistance in ΔE units instead of using visual observations. The area to be stained is set at 2-inch by 1-inch (5 cm by 2.5 cm), e.g., a cut out of these dimensions on cardboard paper; however, the stained area can be any size that can accommodate a spectrophotometer. 9 ml of liquid stains (wine/juice) are applied with an 8-mil gap cube and solid stains are colored on to the sheet rock. The stain caused by ball point pen is omitted in the measured test, because it is not practical to color the 2-inch by 1-inch stained area with a ball point pen.

The visual analysis of the stain resistant test can be used as a screening technique to determine whether to apply the spectrophotometer measured analysis. The visual analysis can also be used for comparative purpose within one experiment or when judged by the same tester(s). The spectrophotometer measured analysis can be used widely across multiple experiments.

A summary of the both the cleansability test (COR-MTD-119) and stain resistant test is shown below.

| Test Method | COR-MTD-119 | New Stain Resistance Test |
|---|---|---|
| Substrate | Leneta drawdown cards | Sheetrock that is primed, |
| | | with two coats of paint |
| Stains | Graphite, Ketchup, | Black and Blue Marker, |
| | Mustard, Coffee, Wine | Crayon, Pencil, Pen, |
| | (3 ml. of liquid) | Lipstick, Wine/Juice (9 |
| | | ml.) |
| Wait time | Stains are sitting on | Stains are applied, and |
| | panels for 10 minutes | then panel is lifted to |
| | before cleaning | vertical position for 1 min, |
| | | and then stains are cleaned. |
| Cleaning Solution | Mild cleaning solution | Same mild cleaning |
| | | solution or Lysol ™ |
| Wipes | 500 cycles | 5 wipes |

Sheetrock or drywalls were used in the stain resistance test to represent walls more accurately. The reason that the sheetrock is slightly cleaned is to remove the solid stains, such as markers, crayon and lipstick, that had adhered to the sheetrock, and the liquid stains need to roll off and gently wiped from the sheetrock before the stain resistance can be determined. The crayon, pencil mark and lipstick are hydrophobic, and the other stains are hydrophilic.

The cleansability test and the stain resistance test measure different properties of the paint film. The cleansability test gauges the ability of the paint film to be cleansed after being stained. The stain resistant test measures the ability of the paint film to resist being stained.

Paint films made with Paint 1/Resin 1 are compared with paint films made from a commercial scuff-resistant eggshell paint and a commercial premium interior eggshell paint manufactured by Benjamin Moore and a premium interior eggshell made by another manufacturer. The paint film's abilities to be cleansed after being stained are shown below in Table 3. The inventive paint 1 has comparable or better cleansability compared to the commercial paints. The results in Table 3 show that the inventive Paint 1 forms films that are cleansable with both hydrophobic and hydrophilic stains.

TABLE 3

| | | Scuff | Interior | Interior |
|---|---|---|---|---|
| | | Resistant | Eggshell | Eggshell |
| | Paint 1 | In-house | In-house | (First 3^{rd} party) |
| Gloss | 21.4 | 13.2 | 8.9 | 8.9 |
| Sheen | 34.2 | 18.2 | 15.7 | 13.7 |
| Scrubbability | 663 | 424 | 942 | 396 |
| (cycles) | | | | |

Cleansability Test (COR-MTD-119)(ΔE)

| | | | | |
|---|---|---|---|---|
| Graphite | 0.34 | 0.09 | 0.87 | 0.12 |
| Ketchup | 0.04 | 0.13 | 0.15 | 0.08 |
| Mustard | 0.05 | 0.15 | 0.08 | 0.12 |
| Wine | 0.08 | 0.36 | 0.49 | 0.16 |
| Coffee | 0.07 | 0.71 | 0.37 | 0.13 |
| TOTAL | 0.58 | 1.44 | 1.96 | 0.61 |

TTP and Litter test (ΔE)

| | | | | |
|---|---|---|---|---|
| TTP | 1.11 | 0.61 | 0.25 | 0.75 |
| Litter | 0.19 | 0.63 | 0.25 | 1.51 |

The 60° gloss values indicate that the paints in Table 3 have eggshell finish (˜10-25 units). The 85° sheen values also indicate that these paints have eggshell finish (10-35 units). The gloss/sheen units are reported in accordance with the gloss values published by the Master Paint Institute (MPI), which are reproduced below.

The results of the stain resistant tests are shown below in Table 4.

TABLE 4

| | | Scuff | Interior | Interior |
|---|---|---|---|---|
| | | Resistant | Eggshell | Eggshell |
| Sheetrock | Paint 1 | In-house | In-house | (First 3^{rd} party) |
| Gloss | 17.5 | 10.0 | 8.3 | 8.7 |
| Sheen | 25.0 | 13.0 | 12.5 | 12.2 |

Stain resistance test over Sheetrock (visual ratings
1-5; 5 = no visual stain)

| | | | | |
|---|---|---|---|---|
| Black marker | 3.5 | 1.0 | 1.5 | 1.0 |
| Blue marker | 4.0 | 1.5 | 1.5 | 1.0 |
| Red crayon | 5.0 | 1.5 | 1.5 | 1.0 |
| 6B pencil | 5.0 | 3.5 | 1.0 | 2.0 |
| Blue pen | 4.0 | 1.0 | 1.0 | 1.0 |
| Red lipstick | 4.5 | 5.0 | 1.0 | 5.0 |
| Berry juice | 5.0 | 5.0 | 4.0 | 5.0 |
| TOTAL | 31.0/35.0 | 18.5/35.0 | 11.5/35.0 | 16.0/35.0 |

Stain resistance test over Sheetrock (ΔE)

| | | | | |
|---|---|---|---|---|
| Black marker | 0.76 | 5.70 | 66.92 | 28.03 |
| Blue marker | 1.03 | 3.16 | 78.42 | 62.43 |
| Red crayon | 0.97 | 2.20 | 1.84 | 1.98 |
| 6B pencil | 0.82 | 1.81 | 0.96 | 0.25 |
| Red lipstick | 2.17 | 2.12 | 2.55 | 0.44 |
| Red cooking | 0.58 | 2.57 | 1.89 | 0.23 |
| wine | | | | |
| TOTAL | 6.33 | 17.56 | 152.58 | 93.36 |

The berry juice is another hydrophilic stain and was used instead of red wine.

The test results in Table 4 show that the inventive architectural composition performed well with both types of stains. The visual stain resistance test shows that inventive Paint 1 resisted both hydrophobic and hydrophilic stains, while the commercial paints displayed good stain resistance for certain stains (4 or 5 score) but poor resistance for other stains (1.0 or 1.5 score). The measured stain resistance test confirmed the visual stain resistance test. The ΔE measurements for the inventive Paint 1 are consistently low indicating good stain resistance. On the other hand, the commercial paints showed significantly lower stain resistance. For two commercial paints, their resistance to stains caused by the hydrophilic black and blue markers is quite low, i.e., ΔE measurements ranging from 28.03 to 78.42, while showing good resistance to the hydrophobic crayon, pencil and lipstick stains, ΔE measurements ranging from 0.25 to 2.55.

The results in Table 4 prove that the inventive paints can resist both hydrophobic and hydrophilic stains.

An additional stain resistance test was conducted with the inventive paint having lower and sheen values, including a matter finish, as compared to the comparative commercial paints, as shown in Table 5. This additional test shows similar results as the test results shown in Table 4. The co-inventors noted that generally for paints with higher pigment content, such as matte finish, it is considerably more difficult to impart stain resistance. Table 5 shows that good stain resistance in the matte finish for the inventive Paint 1 can be accomplished.

TABLE 5

| | | Scuff Resistant | | |
|---|---|---|---|---|
| | Paint 1 | In-house | Paint 1 | Scuff Resistant |
| Sheetrock | Eggshell | Eggshell | Matte | In-house Matte |
| Gloss | 7.8 | 10.8 | 5.7 | 8.0 |
| Sheen | 10.7 | 14.1 | 5.8 | 7.3 |

Stain resistance test over Sheetrock (visual ratings 1-5; 5 = no visual stain)

| | | | | |
|---|---|---|---|---|
| Black marker | 4 | 1 | 4.5 | 1 |
| Blue marker | 3 | 1.5 | 3 | 1.5 |
| Red crayon | 3.5 | 2.5 | 1.5 | 1 |
| 6B pencil | 5 | 4.5 | 4.5 | 5 |
| Blue pen | 5 | 4.5 | 5 | 2 |
| Writing w/pen | 4.5 | 1 | 4.5 | 1 |
| Red lipstick | 3 | 5 | 5 | 3 |
| Red cooking wine | 5 | 5 | 5 | 2 |
| TOTAL | 33/40 | 25/40 | 33/40 | 16.5/40 |

The present inventors also developed other embodiments or examples of the inventive architectural compositions, i.e., Paint 2, utilizing Resin 2, discussed above, respectively. Another batch of Paint 1/Resin 1 is also prepared for this experiment. The cleansability test results are shown in Table 6, and the stain resistant test results are shown in Table 7.

TABLE 6

| Leneta card | Paint 1 | Paint 2 |
|---|---|---|
| Gloss | 24.4 | 22.6 |
| Sheen | 43.2 | 41.9 |

Cleansability Test (COR-MTD-119)(ΔE)

| | | |
|---|---|---|
| Graphite | 0.44 | 0.25 |
| Ketchup | 0.05 | 0.18 |
| Mustard | 0.07 | 0.82 |
| Wine | 0.16 | 1.8 |
| Coffee | 0.31 | 0.82 |
| TOTAL | 1.03 | 3.87 |
| TTP | 1.39 | 2.67 |
| Litter | 0.64 | 0.55 |
| Total | 3.06 | 7.09 |

TABLE 7

| Sheetrock | Paint 1 | Paint 2 |
|---|---|---|
| Gloss | 15.9 | 13.8 |
| Sheen | 23.6 | 21.3 |

Stain resistance test over Sheetrock (visual ratings 1-
5; 5 = no visual stain)

| | | |
|---|---|---|
| Black marker | 4.5 | 4.0 |
| Blue marker | 5.0 | 3.0 |
| Red crayon | 4.5 | 3.0 |
| 6B pencil | 5.0 | 5.0 |
| Blue pen | 5.0 | 5.0 |
| Red lipstick | 4.0 | 3.5 |
| Red cooking wine | 5.0 | 1.0 |
| TOTAL | 33/35 | 24.5/35 |
| Red cooking wine | 0.25 | 2.72 |
| Measured ΔE | | |

The test results in Tables 6 and 7 show that Resin 1 contain mostly (meth)acrylate monomers that are similar to each other and yielded similar cleansability and stain resistance results. Resin 2 contains vinyl and meth (acrylate) monomers and are more hydrophilic than Resin 1. Resin 2 also has larger particle size (360 nm) than Resin 1 (119 nm). The higher hydrophilicity and particle size contribute to less cleansability (Table 6) and less stain resistance (Table 7). As used herein, particle sizes are volume averaged.

Significantly, the stain resistance test results from Paints 1-2, i.e., 33/35 and 24.5/35, respectively, are better than those of the commercial paints shown in Table 4, i.e., from 11.5/35 to 18.5/35. Moreover, red cooking wine stains occupy sufficiently large areas to be measured with a spectrophotometer instrument, and the change between an unstained area and a stained area is significantly lower than 2.0 CIE2000 units for Resin 1 and slightly above 2.0 CIE2000 units for Resin 2.

As discussed in commonly owned U.S. Pat. No. 9,994,722, colors are sufficiently close to each other to be the same color to people when the color differences (ΔE) among them are less than or equal to about 2.0 CIE2000 units, preferably less than about 1.0 CIE2000 unit or less than about 0.5 CIE2000 unit. Experiments have shown that the human eyes should not be able to distinguish colors or can barely distinguish colors that are within 2.0 CIE2000 color difference units from each other.

Additional experiments were conducted to compare the AAEM crosslinking monomer to the DAAM crosslinking monomer, and also to compare copolymer resins that have hydrophobic monomers to copolymer resins that are copolymerized from hydrophilic monomers.

Tables 8A and 8B show the results from these additional experiments. Paints 3-8 have eggshell finish.

TABLE 8A

| Eggshell Finish | Paint 3 | Paint 4 | Paint 5 | Paint 6 |
|---|---|---|---|---|
| Resin | MMA/BA(Resin1 | MMA/2-EHA | MMA/2-EHA | MMA/2-EHA |
| | w/o MA) | | | |
| DAAM | 0 | 4 wt. % in first | 4 wt. % in first | 4 wt. % in |
| | | 70% feed | 70% feed | 100% feed |
| AAEM | 3.56 wt. % in last | 0 | 0 | 0 |
| | 50% feed | | | |
| Others | 1% phosphate | 0.4 wt. % CTA in | | |
| | | last 20% feed | | |
| Morphology | 1-stage | 30% core; 70% | 30% core; 70% | 30% core; 70% |
| | | shell | shell | shell |
| Surfactants | | | | |
| Tg (Fox) | 24° C. | 22° C. | 22° C. | 22° C. |
| | | (68 core, 6 | (68 core, 6 | (68 core, 6 |
| | | shell) | shell) | shell) |
| MFFT (ISO | 28.5° C. | 16° C. | 26° C. | 23° C. |
| 2115) | | | | |
| Particle size | 121 nm | 108 nm | 104.3 nm | 104 nm |
| (volume average) | | | | |

Stain resistance test over Sheetrock (ΔE)

| | | | | |
|---|---|---|---|---|
| Black marker | 1.47 | 5.04 | 5.2 | 7.14 |
| Blue marker | 1.55 | 12.43 | 3.61 | 3.57 |
| Red crayon | 0.66 | 0.49 | 0.37 | 083 |
| 6B pencil | 0.59 | 0.05 | 0.45 | 0.09 |
| Red lipstick | 0.37 | 0.88 | 0.92 | 0.73 |
| Red cooking | 0.43 | 0.25 | 0.18 | 0.28 |
| wine | | | | |
| TOTAL | 5.07 | 19.14 | 10.73 | 12.64 |

TABLE 8B

| | | |
|---|---|---|
| Sheetrock | Paint 7 | Paint 8 |

| Resin | MMA/BA | MMA/BA | |
|---|---|---|---|
| DAAM | 4 wt. % in first | 3 wt. % | |
| | 70% feed | throughout | |
| AAEM | 0 | 0 | |
| Others | | | |
| Morphology | 30% core; 70% | 1 stage | |
| | shell | | |
| Surfactant | | | |
| Tg (Fox) | 22° C. | 15° | C. |

(68 core, 6 shell)

| | | | | |
|---|---|---|---|---|
| MFFT (ISO 2115) | 24° | C. | ~15° | C. |
| Particle size | 109.6 | nm | 145 | nm |

| | | |
|---|---|---|
| (volume average) | | |
| Black marker | 3.33 | 0.39 |
| Blue marker | 1.12 | 0.84 |
| Red crayon | 0.63 | 0.48 |
| 6B pencil | 0.77 | 0.29 |
| Red lipstick | 0.98 | 0.44 |
| Red cooking wine | 0.11 | 0.42 |
| TOTAL | 6.94 | 2.86 |

The experimental results illustrated in Tables 8A and 8B indicate that resins that are more hydrophobic, e.g., with MMA/2-EHA monomers, have lower stain resistance, (Paints 4, 5 and 6). Paints that are less hydrophobic, e.g., with MMA and BA monomers have higher stain resistance.

Additional experiments were conducted with inventive Paint 9 having a matte finish versus other commercial matte paints, as shown in Table 9.

TABLE 9

| | | | | | |
|---|---|---|---|---|---|
| | | | | Interior | Interior |
| | | Interior | Scuff | Matte | Matte |
| | | Matte | Resistant | (Second | (Third 3^{rd} |
| Matte Finish | Paint 9 | In-house | In-house | 3^{rd} Party) | Party) |

Stain resistance test over sheetrock (measured with
spectrophotometer - ΔE)

| | | | | | |
|---|---|---|---|---|---|
| Black marker | 0.51 | 59.91 | 35.03 | 0.82 | 2.40 |
| Blue marker | 3.16 | 58.40 | 29.52 | 2.00 | 6.78 |
| 6B pencil | 0.08 | 0.09 | 0.85 | 0.19 | 0.56 |
| Red crayon | 0.79 | 2.80 | 0.91 | 3.06 | 1.41 |
| Red lipstick | 1.55 | 8.93 | 2.13 | 7.20 | 1.12 |
| Red wine | 1.09 | 0.80 | 1.17 | 0.51 | 0.24 |
| TOTAL | 7.18 | 130.93 | 69.61 | 13.78 | 12.51 |

Table 9 shows further supports highlights that the inventive architectural compositions in the matte finish is capable of resisting both hydrophobic and hydrophilic stains, and resisting stains better than the comparative commercial paints.

While the stain resistant tests are described above, the other standard tests conducted and reported herein are described below.

Scrubbability test results show the number of scrub cycles before failure and the test is conducted pursuant to ASTM D2486 Method B.

The gloss or the gloss finish of a dried paint surface indicates the level of shininess or glass-likeness of the surface. The level of gloss ranges from flat/matte to high gloss. The gloss of a surface can be described as the reflection of light from the surface that is independent of color. To measure gloss, a single beam of light is deflected off the surface at a particular angle into a receptor, as shown below and discussed in http://www.paintinfo.com/mpi/approved/sheen.shtml, which is incorporated herein by reference in its entirety.

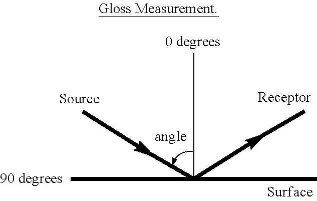

The receptor gauges the intensity of that light in gloss units. The equipment is standardized with specially produced, polished, glass or ceramic tiles. ASTM method D 523 provides the procedures for performing this gloss test.

ASTM method D 523 uses 60° angle for comparing surface glosses and to determine whether other angles such as 20° and 85° are warranted. The 20° angle is used when the surface sample has a 60° gloss value greater than 70 gloss units, and the 85° is used if the 60° gloss value is less than 30 gloss units. Referring to the figure above, the angle is measured from a vertical axis, e.g., a 60° angle is measured from the vertical line or the 0° line, and the 60° angle is 30° above the surface being tested.

Commonly, the term sheen is used to describe the low angle gloss, e.g., 85° from vertical or 5° above the surface to be measured. The 85° angle is preferred in measuring low gloss coatings and is generally a more accurate indicator of the transition between flat and eggshell. Steep angles, such as 20°, are more often used with a high gloss surface such as automotive coatings.

The Master Paint Institute (MPI) categorizes the gloss finishes of paints as follows:

The Reflectivity of Paints with Different Gloss at Different Angles

| Type of Paint Finish | 20° Gloss | 60° Gloss | 85° Sheen |
|---|---|---|---|
| High Gloss | 20-90 | 70-85+ | — |
| Semi-Gloss | 5-45 | 35-70 | — |
| Satin | — | 20-35 | min. 35 |
| Eggshell | | 10-25 | 10-35 |
| Flat/Matte | | 0-10 | max. 35 |

Higher gloss values indicate shinier surfaces.

As discussed in http://www.paintinfo.com/mpi/approved/sheen.shtml, the gloss level of a coating is affected by its surface roughness. The protrusion of pigment or extender particles through the binder layer causes diffraction of light and gives the coating a dullness. Where the pigment or extender particles are covered by the binder layer, the coating surface is smoother and light incident at an angle is readily reflected. The gloss or reflected light can influence the visual color of a surface when viewed from various angles. This can be seen when coating surfaces have been tinted to the same color but with different finishes or gloss levels are applied side-by-side on the same substrate. Viewing from a position directly above and perpendicular to the coating surfaces, with the light directly behind, will show the closest color. Moving the field of view to an angle away from the perpendicular or moving the light source will show a color difference caused by the differences in gloss.

Tg or glass transition temperature can be readily calculated by Fox's equation, as discussed below, which aggregates the weight fraction of each monomer and the Tg of a mono-polymer made entirely from that monomer. The calculated Tg includes the film forming monomers. The cross-linking monomers, and any monomer whose contribution to the polymer is less than about 1.5 wt. % and whose Tg is not widely available, such as wet adhesion monomers are omitted from the Tg calculations. Chain transfer agent is also omitted from the Tg calculations.

The aggregated Tg of a co-polymer calculated by Fox's equation includes the individual Tg of various monomers being co-polymerized, as follows:

$$1 / {Tg}_{agg} = {Wf}_{1} / {Tg}_{1} + {Wf}_{2} / {Tg}_{2} + {Wf}_{x} / {Tg}_{x} ,$$

where Tg_{agg} is the aggregated Tg of the co-polymer
Wfₓ is the weight fraction of each monomer x
Tgₓ is the Tg of a polymer made from the single monomer x
x is the number of monomers in the co-polymer

Differential scanning calorimetry (DSC) can also be used to measured Tg.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments, which would come within the spirit and scope of the present invention.

We claim:

1. An aqueous architectural composition forming a paint film on a substrate capable of resisting hydrophobic and hydrophilic stain comprising:
a film forming latex resin for forming the paint film,
an optional opacifying pigment,
a silicone resin having a weigh molecular weight of greater than about 10,000 and less than about 100,000 Daltons, wherein the silicone resin ranges from about 1 wt. % to about 4 wt. % of the aqueous architectural composition,
a wax microsphere having a mean diameter (D₅₀) ranging from about 6 microns to 18 microns, and ranges from about 3 wt. % to about 9 wt. %, and
at least one organic extender pigment.

2. The aqueous architectural composition of claim 1, wherein the silicone resin ranges from about 1.25 wt. % to about 3.5 wt. % of the aqueous architectural composition.

3. The aqueous architectural composition of claim 2, wherein the silicone resin ranges from about 1.5 wt. % to about 3 wt. % of the aqueous architectural composition.

4. The aqueous architectural composition of claim 1, wherein the weigh molecular weight silicone resin is greater than about 15,000 Daltons.

5. The aqueous architectural composition of claim 4, wherein the weigh molecular weight silicone resin is greater than about 20,000 Daltons.

6. The aqueous architectural composition of claim 5, wherein the weigh molecular weight silicone resin is greater than about 25,000 Daltons.

7. The aqueous architectural composition of claim 1, wherein the weigh molecular weight silicone resin is greater than about 30,000 Daltons.

8. The aqueous architectural composition of claim 1, wherein the wax microsphere is a polyethylene wax microsphere.

9. The aqueous architectural composition of claim 1, wherein the wax microsphere ranges from about 3.5 wt. % to about 8.5 wt. % of the aqueous architectural composition.

10. The aqueous architectural composition of claim 9, wherein the wax microsphere ranges from about 4 wt. % to about 7.5 wt. % of the aqueous architectural composition.

11. The aqueous architectural composition of claim 1, wherein the film forming latex resin comprises a phosphate monomer, wherein the phosphate monomer ranges from 0.1 wt. % to 1 wt. %.

12. The aqueous architectural composition of claim 11, wherein the phosphate monomer ranges from about 0.5 wt. % to about 0.9 wt. %.

13. The aqueous architectural composition of claim 12, wherein the phosphate monomer ranges from about 0.6 wt. % to about 0.8 wt. %.

14. The aqueous architectural composition of claim 1, wherein the film forming latex resin is substantially free of wax seeded latex.

15. The aqueous architectural composition of claim 1, wherein the film forming latex resin comprises (meth)acrylate monomers

16. The aqueous architectural composition of claim 1, wherein the film forming latex resin comprises vinyl and (meth)acrylate monomers.

17. The aqueous architectural composition of claim 1, wherein the Tg for the film forming latex resin ranges from 0° C. to 50° C. as calculated by the Flory Fox equation.

18. The aqueous architectural composition of claim 17, wherein the Tg for the film forming latex resin ranges from 0° C. to 30° C. or from 2.5° C. to 27.5° C. or from 5° C. to 25° C.

19. The aqueous architectural composition of claim 1 further comprising a fluorosurfactant.

20. The aqueous architectural composition of claim 1 further comprising a Gemini surfactant, a polyether-siloxane surfactant, and/or a neutralized alcohol phosphate-type surfactant.
